(19) United States
(12) Patent Application Publication
(10) Pub. No.: US 2009/0045714 A1
(43) Pub. Date: Feb. 19, 2009

(54) UV MODULE SHUTTER EXTRUSION WITH INTERNAL COOLING FINS

(76) Inventor: Michael L. Claeys, Broomfield, CO (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/177,624

(22) Filed: Jul. 22, 2008

Related U.S. Application Data
(60) Provisional application No. 60/964,589, filed on Aug. 13, 2007.

(51) Int. Cl. H01J 7/26; B23P 17/00; H01J 5/18; F28D 15/00

(52) U.S. Cl. 313/35; 29/592.1; 165/104.33; 250/505.1

(57) ABSTRACT

A shutter having at least one coolant passageway, a plurality of ribs extending internally into the coolant passageway. The shutter may be a component of a shutter assembly in a UV module for curing UV-sensitive ink. These ribs may improve heat removal from a UV module in which the shutter is installed. Another advantage is that the shutter of this invention may have a lower weight with consequent advantages of lighter weight, reduced manufacturing costs, and reduced drive train wear.

### CROSS-REFERENCES TO RELATED APPLICATIONS

This application claims priority under 35 U.S.C. §119(e) to, and hereby incorporates by reference, U.S. Provisional Application No. 60/964,589, filed Aug. 13, 2007.

### FIELD OF THE INVENTION

This invention relates to printing presses and, in particular, this invention relates to improved shutters for UV modules used to cure UV-sensitive ink.

### BACKGROUND OF INVENTION

Ultraviolet-sensitive ink is widely used in the printing industry. One reason ultraviolet-sensitive ink is used is that it can be quickly cured by being irradiated by ultraviolet light, the irradiation accomplished by directing a light beam containing high proportions of ultraviolet light at the printed substrate. The cured UV-sensitive ink then does not smear and is not deposited on other surfaces as readily. Lamps used to generate light for this purpose also generate considerable amounts of heat. This heat is usually of little or no consequence when a printing press is operating because the light and heat are directed toward the substrate to cure the UV-sensitive ink. The substrate is also in motion during the printing process. However, if the heat and light generated by the lamp is directed at a nonmoving substrate for a sufficient period of time, the substrate is damaged, often to the point of ignition. Additionally, other nonmoving components of the printing press may be damaged by the high amount of heat generated from the lamps. When the printing press must be halted, for example to clear obstructions or replenish ink supplies, the light generated by the lamp must be prevented from impinging the substrate. One way to prevent irradiating nonmoving substrate is to power down the lamp. However, considerable time is necessary for the lamp to generate sufficient irradiation to cure the ultraviolet-sensitive ink when power is then restored. Consequently, preventing irradiation from impinging nonmoving substrate when a printing press is halted has been accomplished by housing the lamp in a structure having shutters. These shutters can then be opened to allow irradiation or closed to prevent radiation from leaving the structure.

As stated above, intense heat is generated by the UV lamp during operation. These high-energy lamps require high-voltage and fairly high current, some requiring 3000 volts and 17 amps. These high-energy lamps may generate temperatures of 1000 degrees Fahrenheit or more during operation. Consequently, the structures housing these high-energy lamps are subjected to periods of extremely high temperatures. These high temperatures inescapably expand and warp metal components present in the structures. One consequence of this expansion and warpage is failure of the structures to properly operate. Consequently, cooling these structures has been an urgent need and has presented an ongoing problem to the printing industry. There is then a need for a UV module with an efficient cooling capability. There is a particular need for a UV module having shutters with enhanced cooling capability.

### SUMMARY OF THE INVENTION

Accordingly, there is provided a shutter for a UV module, comprising a plurality of fins extending into a coolant passageway, the passageway conveying a coolant flow, e.g., a flow of liquid such as water or a water-polyethylene glycol solution. Heat from the UV module is transferred to the fins, then to the coolant flow and away from the shutter extrusion.

There is also provided a UV module, the UV module including a pair of rotatable shutters, a pair of end caps, and a UV lamp. Each of the shutters may define at least one coolant passageway, a plurality of fins extending into the passageway from a fin base, the fin base including an interior shutter surface. Each of the end caps may be attached to each of the shutters. The UV lamp may be disposed between the shutters. Heat generated from the UV lamp and directed at the shutter interior surface is at least partially conducted from the fin base to the coolant passageway through the plurality of fins.

Methods of making and of using the UV module and/or UV shutter are also provided.

One feature of the improved shutter of this invention is an enlarged overall cross-sectional area and volume of the coolant passageway present in some embodiments of this invention. An advantage of this feature is that the enlarged coolant passageway provides a consequent improvement in overall heat removal capacity of the shutter of this invention.

Another feature of the improved shutter of this invention is that a more direct heat flow path into the coolant is provided for certain embodiments of this invention. An advantage of this feature is that the more direct heat flow path provides for better heat distribution, transfer, and temperature reduction at many of, or all, extrusion locations.

Yet another feature of the improved shutter of this invention is an enlarged passageway to conduct coolant present in certain embodiments of the instant shutter. An advantage of this feature is that the enlarged passageway, with optionally integral fins, provides better module cooling. Another advantage of this feature is that the larger size of the passageway directly equates to a greater volume of coolant available to dissipate a greater quantity of heat.

The integral cooling fins, if present, maybe associated with the integral fin base and may conduct more heat energy into the coolant more quickly and more effectively by virtue of the larger wetted surface area of the coolant passageway and the internal cooling fins. The cooling fins may also induce a more turbulent flow of the coolant within the coolant passageways, thereby mixing the coolant to encourage better heat transfer.

By virtue of the geometry of the profile of the fin base of this invention, the much shorter and therefore more direct heat path from the exposed surface to the wetted areas in the interior of the passageway allows more heat to be transferred into the coolant.

The enlarged inner surface of the passageway of this invention further contributes to the improved heat transfer capabilities of the shutter extrusion. The larger wetted surface area situated opposite the internal fins may enable a higher degree of heat transfer from the surrounding atmosphere in the immediate vicinity of the UV module. This higher degree of heat transfer may contribute to decreasing the ambient air temperature within the module environment. The larger surface area along the passageway inside the back of the shutter may also facilitate the module to cool more quickly after the lamp has been powered down. Cooling the module more quickly is highly desirable for safe module handling.

The combination of the larger coolant passageway and integral internal cooling fins present in certain embodiments of the shutter of this invention may result in a reduction of heat-induced shutter warpage and associated operational problems. Because the outermost arrangement of the aluminum shutter extrusion remains intact, revised shutter configuration may retain approximately the same general bending, torsional, and warpage resistance found in the original shutter configuration.

Because the shutter extrusion of this invention may incorporate the original outer profile, yet feature a larger coolant passageway, the improved shutter extrusion of this invention may be constructed using less material per unit length. Consequently, the shutter of this invention may be manufactured at a lower cost.

Each of the shutter assemblies of this invention may be mounted in a UV module with its center of rotation some distance away from the center of gravity of the shutter extrusion. Accordingly, a shutter of lighter weight may be desirable to ease the stresses and wear rates on the drive mechanisms operating and closing the shutters. Reductions in drive train stress and wear can thereby contribute to increased longevity and reliable operation of the shutter drive train components and may result in a savings in repair time, down time, and material costs. The lighter shutter of this invention may further provide for easier module handling.

These and other objects, features, and advantages of this invention will become apparent from the description which follows, when considered in view of the accompanying drawings.

### BRIEF DESCRIPTION OF THE DRAWINGS

FIG. 1 is a side view of a UV module, which can be used in conjunction with the improved shutter of this invention.

FIG. 2 is a cross-section of a UV module of the prior art along line A-A of FIG. 1.

FIG. 3 is a cross-section of the right shutter of the prior art depicted in more detail in FIG. 2.

FIG. 4 is a cross-section of a shutter of this invention.

FIG. 5 is a perspective view of another shutter of this invention.

It is understood that the above-described figures are only illustrative of the present invention and are not contemplated to limit the scope thereof.

### DETAILED DESCRIPTION

Any references to such relative terms as right and left or the like are intended for convenience of description and are not intended to limit the present invention or its components to any one positional or spatial orientation. Each of the features and methods disclosed herein may be utilized separately or in conjunction with other features and methods to provide improved devices of this invention and methods for making and using the same. Representative examples of the teachings of the present invention, which examples utilize many of these features and methods in conjunction, will now be described in detail with reference to the drawings. This detailed description is merely intended to teach a person of skill in the art further details for practicing preferred aspects of the present teachings and is not intended to limit the scope of the invention. Therefore, combinations of features and methods disclosed in the following detailed description may not be necessary to practice the invention in the broadest sense and are instead taught merely to particularly describe representative and preferred embodiments of the invention.

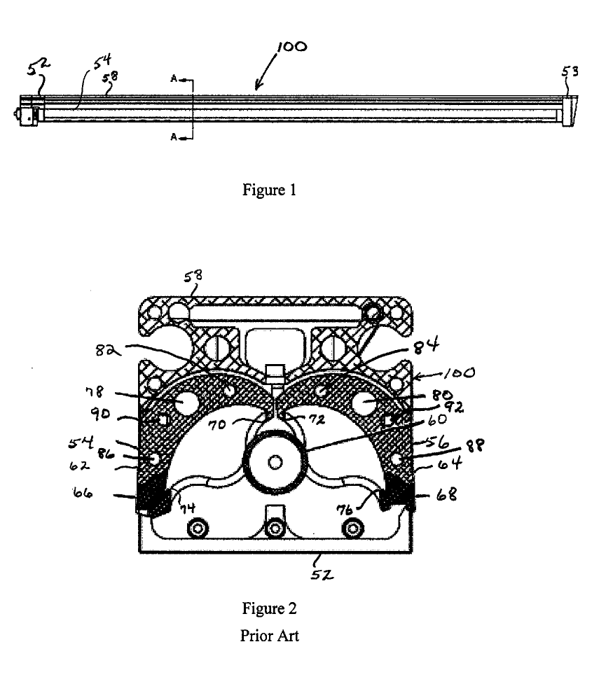

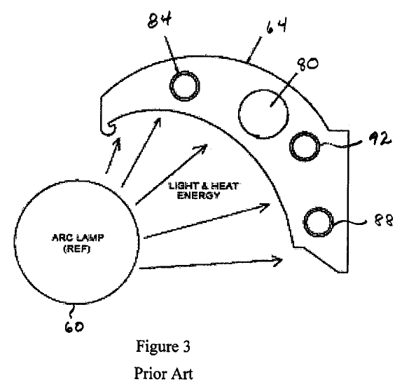

Referring to FIGS. 1, 2, and 3, a UV module 100 is shown having end caps 52, 53, left shutter assembly 54, right shutter assembly 56, and a module body 58. One suitable embodiment of the UV module 100 is disclosed in U.S. patent application Ser. No. 12/001,080, filed 7 Dec. 2007 and entitled UV Module, the disclosure of which is hereby incorporated by reference. The UV module 100 encloses a UV lamp 60 and reflects radiation from the UV lamp 60 toward a substrate being printed on a printing press. The left and right shutter assemblies 54, 56 include respective left and right shutters 62, 64, positive and negative retainers 66, 68 and reflector mounts 70, 72, 74, 76. Replaceable reflectors (not shown) may be attached and held in place between the reflector mount pairs 70, 74 and 72, 76, the positive and negative retainers 66, 68 being removed and reattached during reflector replacement. The left and right shutters 62, 64 are rotated to open and close, thereby allowing irradiation of a substrate by the lamp 60 when open or to prevent irradiation when closed. The left and right shutters 62, 64 define respective coolant passageways 78, 80 and bolt holes 82, 84, 86, 88, 90 and 92 are present to attach the left and right shutters 62, 64 to the end caps 52, 53 by accommodating threaded bolts therethrough. Coolant passageways 78, 80 conduct a fluid, such as air, water or a water-polyethylene glycol solution to cool the shutters 62, 64 when the UV lamp 60 is generating heat during operation. As stated above, the shutters 62, 64 are rotated along their longitudinal axes to open and close in proximity to the UV lamp 60.

During normal operation the UV lamp 60 generates large amounts of undesirable heat often inducing temperatures believed to be in the range of 1000-1300 degrees Fahrenheit at portions of the shutter surfaces exposed to the UV lamp 60. If not cooled, these high temperatures can damage the shutters 62, 64, for example, by inducing warpage. To remove this undesired heat, the shutters 62, 64 are equipped with coolant passageways 78, 80 along the entire lengths thereof Coolant fluid is conducted through the passageways 78, 80 to remove the heat from the shutters 62, 64, the heat from the coolant being subsequently dissipated remotely, e.g., by using a heat exchanger.

Although air could be conducted through the passageways 78, 80, as well as the passageways of the shutter of this invention (described below), liquid-cooled shutters provide several advantages over air-cooled shutters. The specific heat capacity of water is approximately four times greater than that of air, while the heat transfer coefficient for heat passing from aluminum to water is at least 30 times greater than that for heat transferred from aluminum to air. Liquid cooling is, therefore, more efficient than air cooling for carrying away the large quantities of heat energy produced by the lamp 60. Along with minimizing excess warpage and reducing the possibility of heat-induced damage to the shutters and other components disposed near the lamp 60, another positive feature of liquid-cooled shutters is the relatively quick module cool down rate allowing the module to be safely handled, which occurs sooner after the lamp has been shut off.

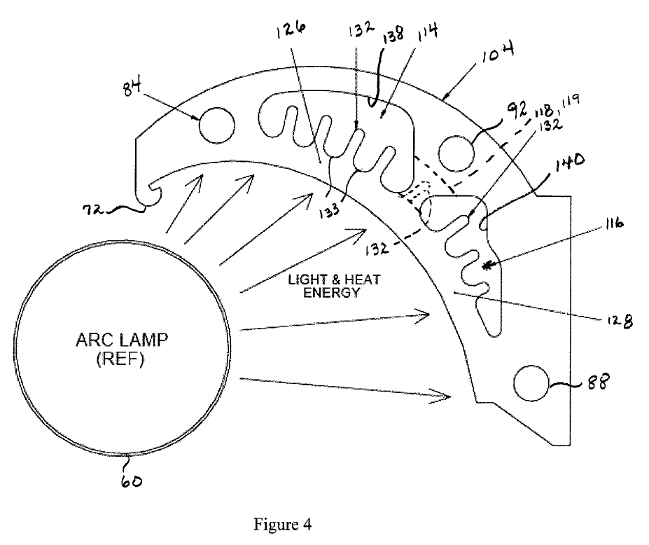

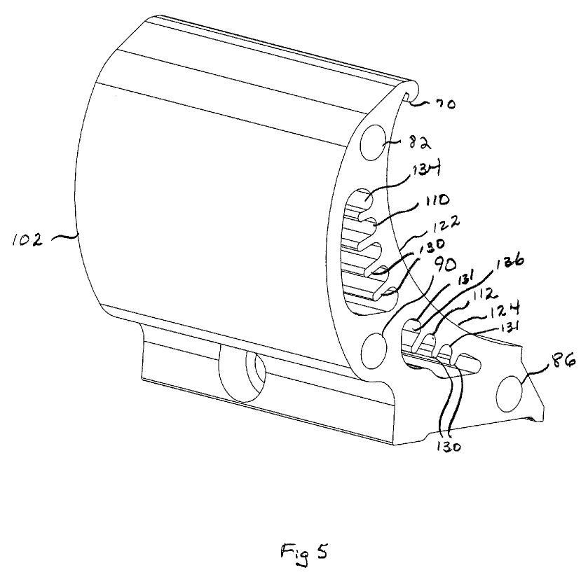

Referring to FIGS. 4 and 5, respective left and right shutters (or shutter extrusions) 102, 104 are present in the UV module 100 and advantageously define at least one coolant passageway, e.g., passageways 110, 112 and 114, 116. Alternatively, the passageway pairs 110, 112 and 114, 116 may be joined by a coolant passageway extension 118 into a single coolant passageway 119. The passageways 110, 112, 114, 116 (or 119) are bordered by respective fin bases 122, 124, 126, 128 on interior portions of the left and right shutters 102, 104. Respective fins 130 and 132 extend from interstitial portions 131, 133 of the fin bases 122, 124, 126, 128 into the coolant passageways 110, 112, 114, 116. Accordingly, interior surfaces 134. 136, 138, 140 of respective passageways 110, 112, 114, 116 have the fins 130, 132 and interstitial portions 131, 33 present in portions nearest the lamp 60. Except for the presence of the coolant passageways 110, 112, 114, 116 (or 119), the external configurations of the crescent-shaped profile of the instant shutters 100, 102 are unchanged in the embodiment shown, thus are interchangeable.

The coolant passageways 110, 112, 114, 116 conduct coolant through the shutters 102, 104 more efficiently by means of a cross-sectional area approximately twice as large as the coolant passageways 80, 82 in one embodiment. Consequently, the passageways 110, 112, 114, 116 (or 119) permit a proportionally larger volume of coolant flow and an increase in the amount of heat energy removed. Additionally, the shutters 102, 104 weigh less than the shutters 54, 56 due to the lower amount of material replaced by the passageways 110, 112, 114, 116 (or 119). Hence, the shutters 102, 104 cost less to build and require less energy to open and close. The coolant passageways of this invention, at least one in number per shutter, thus provide an advantageous combination of extrusion thickness, cooling capability, and weight reduction.

The integral cooling fins 130, 132 extend into the coolant passageways 110, 112, 114, 116 to greatly enhance heat transfer away from the shutter surface exposed to the UV lamp 60 and into the flow of liquid coolant. The fins 130, 132 may additionally add a degree of extrusion thickness and warpage resistance.

The wetted internal surface areas (134, 136, 138, 140 of the passageways 110, 112, 114, 116 may be more than about four times greater than the surface area of the passageways 78, 80, thus greatly improving heat transfer effectiveness. This greater surface area may provide an increase in module cooling capacity of five to 20 percent in some embodiments. The enlarged and reshaped passageways 110, 112, 114, 116 may also provide for a larger internal wetted area for heat transfer from the outer surfaces of the shutter extrusion, thereby achieving a cooled UV module more quickly. Cooler UV modules resulting from the improved passageways of this invention may result in attendants being able to handle the UV module more quickly after the lamp is shut down. Custom-made shutter end caps may be present to conduct coolant to and from the shutters 100, 102. Sealants such as O-rings may be present between the shutter end caps and the shutters of this invention.

The cooling fins 130, 132 protrude into the coolant passageways 110, 112, 114, 116 (or 119) to conduct heat energy away from the fin bases 122, 124, 126, 128, which are attached to, or in the vicinity of, the heat source, UV lamp 60, and into the cooling fins. The cooling fins 130, 132 subsequently conduct the heat into the cooler surrounding media, fluid coolant. The relatively large amount of exposed area of the cooling fins 130, 132, is therefore a key factor enabling the enhanced heat transfer of the shutter of this invention. Other factors include the type of cooling media utilized and the fin and fin base materials. The coolant media used to cool the improved UV module of this invention may be air; however, water or a water-polyethylene glycol solution may be preferred in some embodiments for reasons stated above. If present, the water-polyethylene glycol solution may be any desired concentration.

In the improved shutters of this invention, the cooling fin bases 122, 124, 126, 128 define a plurality of inner surfaces of the passageways 110, 112, 114, 116 by way of the fins 130, 132 and interstitial portions 131.133. Alternatively, the fins 130, 132 may not be present, the improved passageways thus having larger cross-sectional areas. If fins 130, 132 are present, the outer surface of the fin bases 122, 124, 126, 128 define surfaces directly exposed to the large amount of undesirable heat energy emitted from the UV lamp 60. As the fin bases 122, 124, 126, 128 are heated by the lamp 60, heat flows through the fin bases 122, 124, 126, 128 and into the much cooler fins 130, 132 and interstitial portions 131, 133. Coolant flowing past the fins 130, 132 and interstitial portions 131, 133 absorbs heat energy from the fins 130, 132 and interstitial portions 131, 133. The heat energy present within the coolant may then be dissipated (removed) by an external heat exchanger (not shown). The fin base surface area of the shutter of this invention is, consequently, several times larger than that found in the prior art and provides the most direct and effective pathway for conducting heat from the outer extrusion surface to the coolant fluid.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A shutter for a UV module, said shutter rotating between an open position and a closed position and comprising a plurality of fins extending into a coolant passageway, said passageway conveying a liquid coolant flow, heat from the UV module transferred to said fins, then to said coolant flow.

2. The shutter of claim 1, wherein said coolant flow comprises water.

3. The shutter of claim 2, wherein said coolant flow further comprises polyethylene glycol.

4. The shutter of claim 1, wherein a plurality of coolant passageways are present.

5. The shutter of claim 1, further comprising a pair of reflector mounts.

6. A UV module comprising:
a pair of shutters, each of said shutters rotating between open and closed positions and defining at least one coolant passageway, a plurality of fins extending into said passageway from a fin base, said fin base including an interior shutter surface;
a pair of end caps attached to each of said shutters; and
a UV lamp disposed between said shutters,
said UV lamp generating heat and directing said generated heat toward said shutter interior surface, said heat being at least partially conducted from said fin base to said coolant passageway through said plurality of fins.

7. The UV module of claim 6, further comprising a coolant flowing in said passageway.

8. The UV module of claim 7, wherein said coolant comprises water.

9. The UV module of claim 8, wherein said coolant further comprises polyethylene glycol.

10. The UV module of claim 6, wherein a pair of coolant passageways are present in each of said shutters.

11. A method of manufacturing a rotatable shutter for a UV printing module, comprising: extruding a pair of shutters so that each shutter defines a plurality of fins extending into a longitudinal coolant passageway for conducting a liquid coolant therethrough.

12. The method of claim 11, in which a plurality of coolant passageways are defined.

13. The method of claim 11, in which the shutter includes an integral retainer.

14. The method of claim 13, further comprising attaching a positive or negative retainer to the shutter.

15. A method of manufacturing a LV module, comprising attaching a pair of rotatable shutters of claim 11 to a pair of end caps.

16. The method of claim 15, further comprising attaching a UV lamp to said UV module.

17. The method of claim 16, in which each of said shutters defines a plurality of coolant passageways.

18. A method of cooling a shutter extrusion, comprising flowing a liquid through a first coolant passageway, a plurality of fins extending into said first coolant passageway.

19. The method of claim 18, further comprising flowing a liquid through a second coolant passageway, a plurality of fines extending into said second coolant passageway.

20. The method of claim 18, wherein said liquid comprises water.

21. The method of claim 20, wherein said liquid further comprises polyethylene glycol.
